(19) United States
(12) Patent Application Publication
(10) Pub. No.: US 2019/0100145 A1
(43) Pub. Date: Apr. 4, 2019

(54) THREE-DIMENSIONAL IMAGE DRIVING ASSISTANCE DEVICE

(71) Applicant: Hua-chuang Automobile Information Technical Center Co., Ltd., New Taipei City (TW)

(72) Inventors: Le-Hung Chen, New Taipei City (TW); Yong-Jhou Chen, New Taipei City (TW); Yen-Po Fang, New Taipei City (TW)

(21) Appl. No.: 15/722,345

(22) Filed: Oct. 2, 2017

(51) Int. Cl. B60R 1/00; B60K 35/00; B60Q 1/00; G03B 37/04; G01C 21/36

(52) U.S. Cl. CPC B60R 1/002; B60K 35/00; B60Q 1/0023; G03B 37/04; G01C 21/3647; B60R 2300/607; B60K 2350/1076; B60K 2350/2017; B60K 2350/2052; B60R 2300/202; B60R 2300/8026; G01C 21/365

(57) ABSTRACT

A three-dimensional image driving assistance device is applied to a vehicle. The vehicle includes a plurality of vehicle body pillars. The three-dimensional image driving assistance device includes a lens group, a three-dimensional image processing module, an image retrieval module, and a plurality of display modules. The lens group photographing a plurality of external images around the vehicle and outputting the external images. The three-dimensional image processing module receives the external images, combines the external images into a planar panoramic image, and then synthesizes the planar panoramic image into a three-dimensional panoramic projection image. The image retrieval module retrieves a part of the three-dimensional panoramic projection image, and converts the part of the three-dimensional panoramic projection image into a plurality of partial three-dimensional blind spot images. The plurality of display modules is respectively disposed on the vehicle body pillars, and each display module displays a partial three-dimensional blind spot image.

### BACKGROUND

### Technical Field

The present invention relates to an image assistance device, and more particularly to a three-dimensional image driving assistance device.

### Related Art

For a long time, most traffic accidents that occur during the travel of vehicles are caused by blind spots in vision that are caused by vehicle body structures (for example, A-pillars, B-pillars or C-pillars). For example, when a driver steers a vehicle, an A-pillar of the vehicle easily blocks the sight of a pedestrian, a vehicle or a traffic sign in front to cause a traffic accident. A B-pillar easily blocks the sight of a moving object on a side of the vehicle, and as a result, when the driver steers the vehicle or changes lanes, the vehicle easily collides with a nearby vehicle.

In view of the foregoing problem, currently, in a commercially available solution, a camera is disposed at a blind spot of a vehicle to photograph a picture blocked in a blind spot area, and the picture is displayed on a screen of a dashboard, so that a driver observes the picture to avoid an accident. However, considering the actual experience of use, when a driver steers a vehicle or changes lanes, the line of sight of the driver is not on a dashboard in front. At this time, if the driver moves the line of sight to a screen to observe a picture of a blind spot area, such an unnatural act easily causes a traffic accident. In addition, the picture photographed by the camera is usually deformed, making it impossible for a driver to accurately distinguish the shape and size of an object outside the vehicle and a distance between the object and the vehicle. It is really necessary to make an improvement or breakthrough.

### SUMMARY

In view of the foregoing problem, in an embodiment, a three-dimensional image driving assistance device is provided, applied to a vehicle. The vehicle includes a plurality of vehicle body pillars. The three-dimensional image driving assistance device includes a lens group, a three-dimensional image processing module, an image retrieval module, and a plurality of display modules. The lens group includes a plurality of lenses, respectively disposed on different positions around the vehicle, and the lenses respectively photographing a plurality of external images around the vehicle and outputting the external images. The three-dimensional image processing module is electrically connected to the lens group. The three-dimensional image processing module receives the external images, combines the external images into a planar panoramic image, then synthesizes the planar panoramic image into a three-dimensional panoramic projection image by using a back projection manner, and outputs the three-dimensional panoramic projection image. The image retrieval module is electrically connected to the three-dimensional image processing module. The image retrieval module receives the three-dimensional panoramic projection image, retrieves a part of the three-dimensional panoramic projection image, and converts the part of the three-dimensional panoramic projection image into a plurality of partial three-dimensional blind spot images.

The partial three-dimensional blind spot images respectively correspond to outside views blocked by the vehicle body pillars. The image retrieval module selectively outputs at least one of the partial three-dimensional blind spot images. The plurality of display modules is electrically connected to the image retrieval module. The display modules are respectively disposed on the vehicle body pillars, and each display module receives and displays a partial three-dimensional blind spot image of a corresponding vehicle body pillar.

Therefore, in the present invention, by means of image processing and synthesis, a three-dimensional panoramic projection image is first established, and then corresponding to parts of vehicle body pillars (for example, A-pillars, B-pillars or C-pillars of a vehicle or at least two of the A-pillars, B-pillars or C-pillars), corresponding partial three-dimensional panoramic projection images are retrieved and displayed at the vehicle body pillars, so that a driver can see outside views blocked by the vehicle body pillars during driving, and a synthesized three-dimensional panoramic projection image further provides three-dimensional perception to realistically present the surrounding environment of the vehicle, thereby achieving the efficacy of meeting the position of the line of sight of a driver when the driver drives a vehicle and improving the driving safety.

### BRIEF DESCRIPTION OF THE DRAWINGS

The present invention will become more fully understood from the detailed description given herein below for illustration only, and thus are not limitative of the present invention, and wherein:

FIG. 1 is a perspective view of a configuration of a lens group according to the present invention.

FIG. 2 is a device block diagram of a first embodiment of a three-dimensional image driving assistance device according to the present invention.

FIG. 3 is a device block diagram of a second embodiment of a three-dimensional image driving assistance device according to the present invention.

FIG. 4 is a schematic diagram of a panoramic projection of a three-dimensional image driving assistance device according to the present invention.

FIG. 5 is a schematic diagram of retrieval by a three-dimensional image driving assistance device according to the present invention.

FIG. 6 is a correspondence diagram of retrieval by a three-dimensional image driving assistance device according to the present invention.

FIG. 7 is a schematic diagram of a display of a display module according to the present invention.

FIG. 8 is a schematic diagram of a display of another embodiment of a display module according to the present invention.

### DETAILED DESCRIPTION

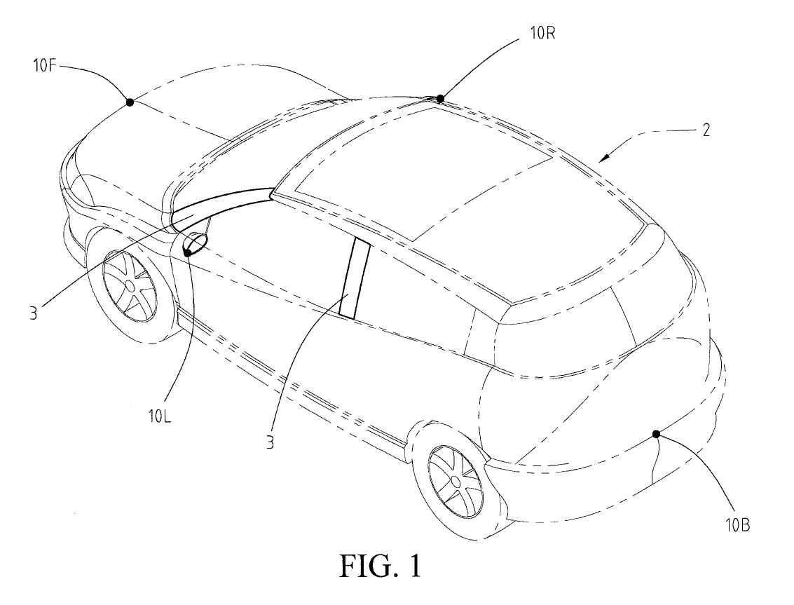

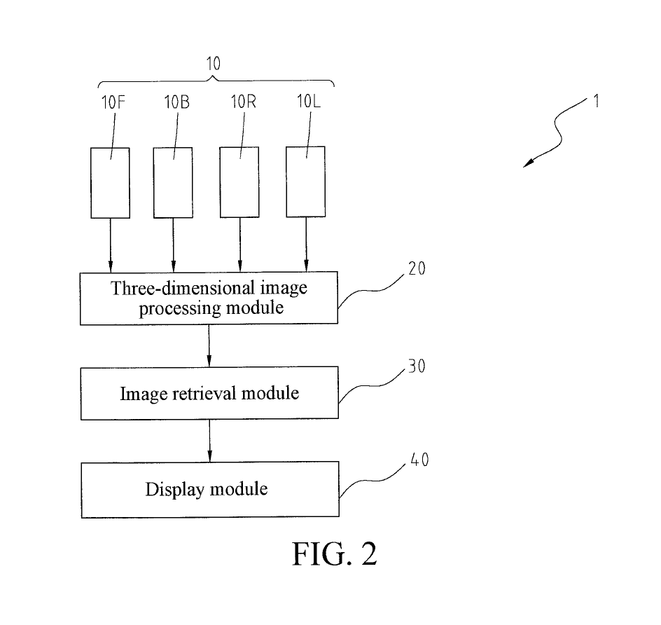

Referring to FIG. 1 and FIG. 2, in this embodiment, a three-dimensional image driving assistance device 1 includes a lens group 10, a three-dimensional image processing module 20, an image retrieval module 30, and a plurality of display modules 40.

As shown in FIG. 1, the lens group 10 includes a front-view lens 10F, a rear-view lens 10B, a left-view lens 10L, and a right-view lens 10R. The front-view lens 10F is mounted in the front of a vehicle 2. For example, the front-view lens 10F may be disposed on a hood or at a hood scoop in the front, so as to photograph a vehicle-body front-side image I_{F} (that is, an external image in front of the vehicle 2). The rear-view lens 10B is mounted in the rear of the vehicle 2. For example, the rear-view lens 10B may be disposed on a trunk cover, to photograph a vehicle-body rear-side image I_{B} (that is, an external image in rear of the vehicle 2). The left-view lens 10L and the right-view lens 10R are respectively mounted on a left side and a right side of the vehicle 2. For example, the left-view lens 10L is mounted on a left side-view mirror to photograph a vehicle-body left-side image I_{L} (that is, an external image on the left of the vehicle 2). The right-view lens 10R may be mounted on a right side-view mirror to photograph a vehicle-body right-side image I_{R} (that is, an external image on the right of the vehicle 2). In fact, the quantity and angles of the lenses may all be adjusted according to an actual requirement. The foregoing description is only an example, but is not intended to constitute any limitation.

In addition, the front-view lens 10F, the rear-view lens 10B, the left-view lens 10L, and the right-view lens 10R may be specifically wide-angle lenses or fisheye lenses. The vehicle-body front-side image I_{F}, the vehicle-body rear-side image I_{B}, the vehicle-body left-side image I_{L}, and the vehicle-body right-side image I_{R} at least partially overlap each other. That is, the vehicle-body front-side image I_{F}, the vehicle-body rear-side image I_{B}, the vehicle-body left-side image I_{L}, and the vehicle-body right-side image I_{R} may all partially overlap each other without any gap, so as to obtain a complete image around the vehicle 2. The lens group 10 outputs the vehicle-body front-side image I_{F}, the vehicle-body rear-side image I_{B}, the vehicle-body left-side image I_{L}, and the vehicle-body right-side image I_{R}.

As shown in FIG. 2, the three-dimensional image processing module 20 may be specifically implemented by using a microcomputer, a processor or a dedicated chip, and the three-dimensional image processing module 20 may be mounted on the vehicle 2. The three-dimensional image processing module 20 is electrically connected to the front-view lens 10F, the rear-view lens 10B, the left-view lens 10L, and the right-view lens 10R. The three-dimensional image processing module 20 receives and may first combine the vehicle-body front-side image I_{F}, the vehicle-body rear-side image I_{B}, the vehicle-body left-side image I_{L}, and the vehicle-body right-side image I_{R} into a planar panoramic image, then synthesizes the planar panoramic image into a three-dimensional panoramic projection image Iₛᵤᵣᵣ by using a back projection manner, and outputs the three-dimensional panoramic projection image Iₛᵤᵣᵣ.

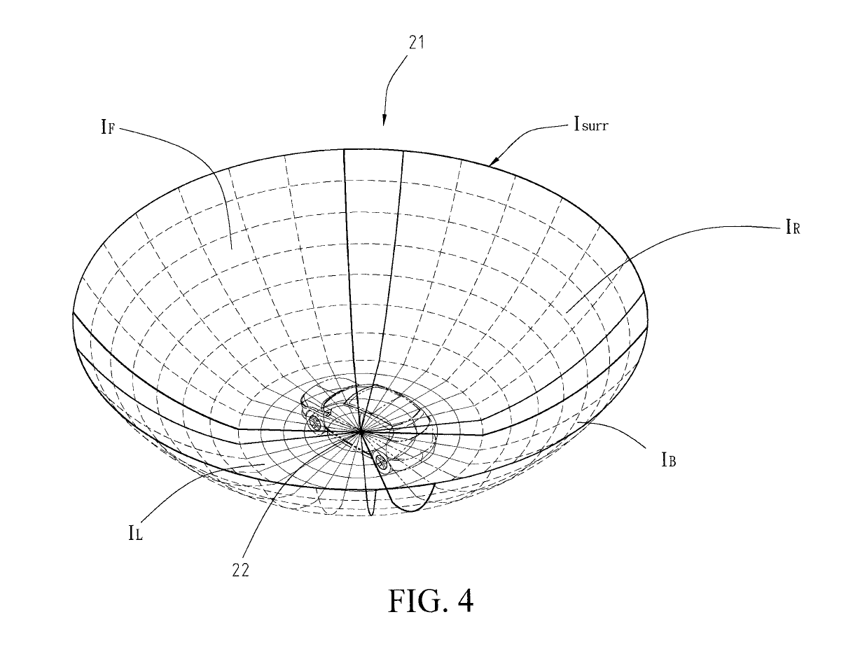

Alternatively, referring to FIG. 4, in this embodiment, the three-dimensional image processing module 20 projects the vehicle-body front-side image IF, the vehicle-body rear-side image I_{B}, the vehicle-body left-side image I_{L}, and the vehicle-body right-side image I_{R} onto a 3D panoramic model 21 to synthesize the three-dimensional panoramic projection image Iₛᵤᵣᵣ. Edges of the projections of the vehicle-body front-side image IF, the vehicle-body rear-side image I_{B}, the vehicle-body left-side image I_{L}, and the vehicle-body right-side image I_{R} onto the 3D panoramic model 21 overlap each other. Therefore, the three-dimensional panoramic projection image Iₛᵤᵣᵣ may present a 3D around-view image around the vehicle 2.

That is, the three-dimensional panoramic projection image Iₛᵤᵣᵣ further provides three-dimensional perception to realistically present the surrounding environment of the vehicle, so as to enable a driver to easily and intuitively recognize a height difference of a nearby object and a distance from the nearby object. In addition, a coordinate center position 22 of the 3D panoramic model 21 corresponds to the position of the driver of the vehicle 2. That is, the synthesized three-dimensional panoramic projection image Iₛᵤᵣᵣ meets the observation view of the driver. The three-dimensional image processing module 20 may obtain the position (for example, the coordinates of the driver) of the driver by using a GPS positioning system, so as to correct the coordinate center position 22 of the 3D panoramic model 21 to the position of the driver. However, the present invention is not limited to this manner.

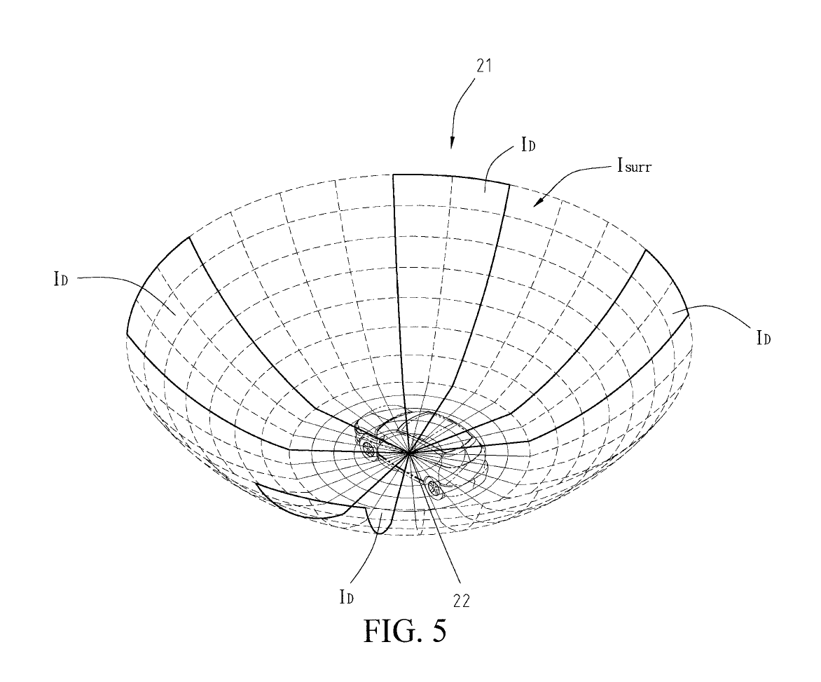

Referring to both FIG. 2 and FIG. 5, the image retrieval module 30 may be specifically implemented by using a microcomputer, a processor or a dedicated chip. The image retrieval module 30 may be mounted on the vehicle 2 and be electrically connected to the three-dimensional image processing module 20. The image retrieval module 30 receives the three-dimensional panoramic projection image Iₛᵤᵣᵣ, retrieves a part of the three-dimensional panoramic projection image Iₛᵤᵣᵣ, and converts the part of the three-dimensional panoramic projection image Iₛᵤᵣᵣ into a plurality of partial three-dimensional blind spot images I_{D}. The partial three-dimensional blind spot images I_{D} respectively correspond to outside views blocked by vehicle body pillars 3 (for example, A-pillars, B-pillars or C-pillars of the vehicle 2 or at least one of the A-pillars, B-pillars or C-pillars) of the vehicle 2. The image retrieval module 30 selectively outputs at least one of the plurality of partial three-dimensional blind spot images I_{D}. That is, the image retrieval module 30 may directly output the partial three-dimensional blind spot images I_{D}, or may alternatively determine, after receiving a specific signal or specific information, whether to output the partial three-dimensional blind spot images I_{D}. This is described in detail below.

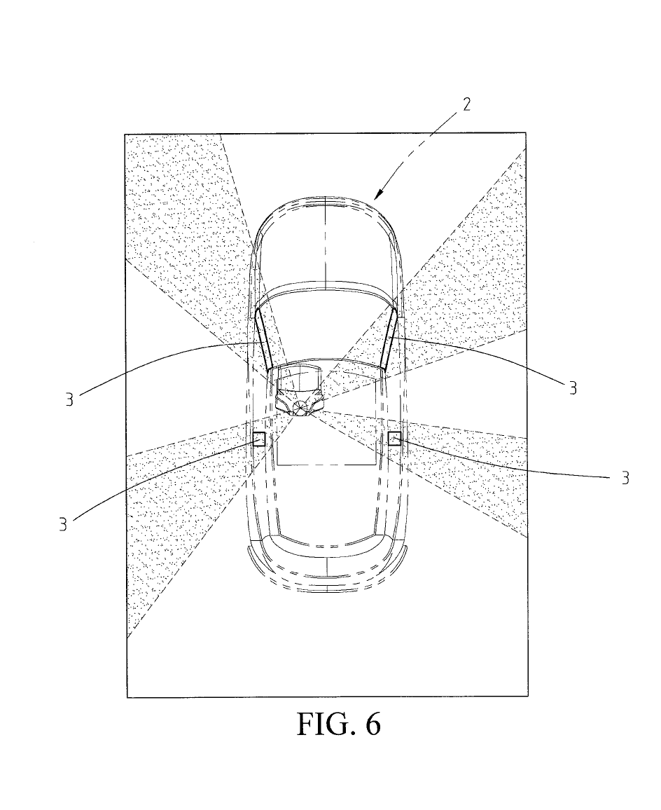

Further, referring to both FIG. 5 and FIG. 6, in this embodiment, the image retrieval module 30 retrieves corresponding partial images (that is, partial three-dimensional blind spot images I_{D}) in the three-dimensional panoramic projection image Iₛᵤᵣᵣ in a view range of observing the vehicle body pillars 3 (A-pillars and B-pillars of the vehicle 2 here) by a corresponding driver. That is, the partial three-dimensional blind spot images I_{D} are outside images blocked by the vehicle body pillars 3.

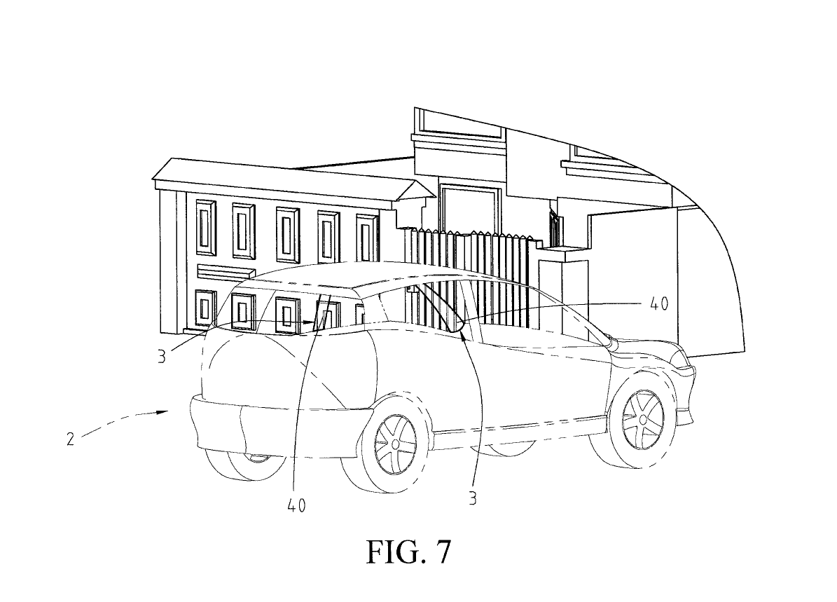

Referring to FIG. 7 together, the plurality of display modules 40 may be specifically a display screen and be electrically connected to the image retrieval module 30. The display modules 40 are respectively disposed on the vehicle body pillars 3. For example, the display modules 40 may be attached to surfaces of the vehicle body pillars 3 inside the vehicle or inserted in the vehicle body pillars 3. Each display module 40 receives and displays a partial three-dimensional blind spot image I_{D} of a corresponding vehicle body pillar 3. For example, a display module 40 located at an A-pillar of the vehicle 2 receives and displays a partial three-dimensional blind spot image I_{D} blocked by the A-pillar, to enable a driver to observe an outside view blocked by the A-pillar that is. That is, an effect similar to that the driver sees through the A-pillar can be achieved, thereby further meeting the position of the line of sight of a driver when the driver drives a vehicle and improving the driving safety. In this embodiment, a display module 40 located between an A-pillar and a B-pillar of the vehicle 2 synchronously receives and displays partial three-dimensional blind spot images I_{D} blocked by both the A-pillar and the B-pillar, to enable the A-pillar and the B-pillar to display blocked outside views. In addition, in some aspects, each display module 40 may be a flexible display, and can be bent and attached along with the surface curvature of each vehicle body pillar 3 or inserted along with the surface curvature of the vehicle body pillar 3, thereby enhancing the appearance.

In addition, the lens group 10, the three-dimensional image processing module 20, the image retrieval module 30, and the plurality of display modules 40 may be connected by using a controller area network, so as to transfer data or signals to each other.

The image retrieval module 30 may determine, after receiving a specific signal or specific information, whether to output the partial three-dimensional blind spot images I_{D}. This is described as follows with reference to embodiments.

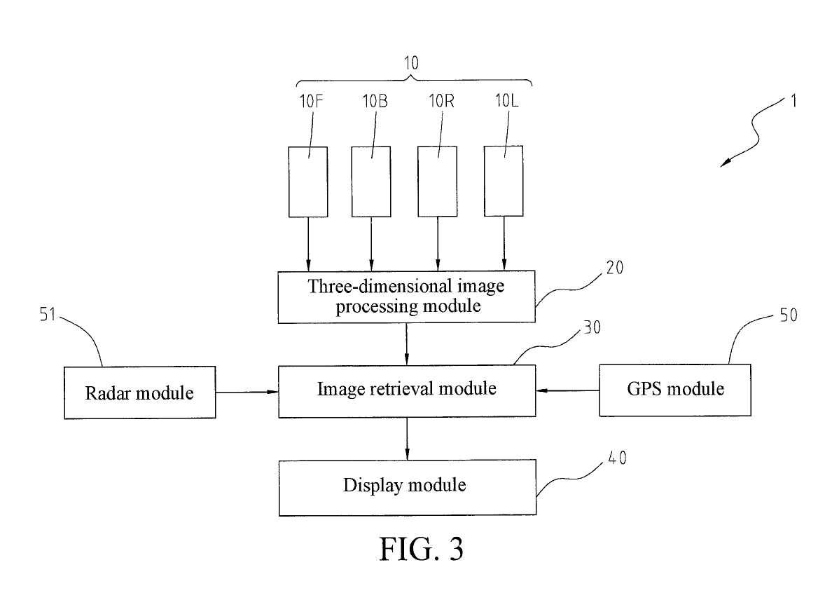

As shown in FIG. 3, in this embodiment, the three-dimensional image driving assistance device 1 further includes a GPS module 50, electrically connected to the image retrieval module 30, so as to detect and output vehicle position information (that is, the position of the vehicle). The image retrieval module 30 determines, corresponding to the vehicle position information, whether to output at least one of a plurality of partial three-dimensional blind spot images I_{D}. For example, the GPS module 50 may be located in a navigation device. The image retrieval module 30 may output a partial three-dimensional blind spot image I_{D} blocked by at least one of an A-pillar or a B-pillar when the vehicle position information shows that the vehicle is in an alley or at a crossing, thereby ensuring the driving safety.

As further shown in FIG. 3, in this embodiment, the three-dimensional image driving assistance device 1 further includes a radar module 51, electrically connected to the image retrieval module 30 and disposed outside the vehicle 2. For example, the radar module 51 may include a plurality of ranging radars such as laser radars, infrared radars or radio radars respectively mounted around the vehicle 2. The radar module 51 may detect the approach of an object around the vehicle 2 to output a proximity signal. The image retrieval module 30 outputs, corresponding to the proximity signal, at least one of the partial three-dimensional blind spot images I_{D}. For example, when another vehicle approaches from the right side, the radar module 51 sends a proximity signal. The image retrieval module 30 receives the proximity signal and then outputs a partial three-dimensional blind spot image I_{D} corresponding to a B-pillar on the right side, to enable a display module 40 on the B-pillar on the right side to display an outside image blocked by the B-pillar on the right side, so as to prevent the driver from missing the approaching vehicle from the right side because of being blocked by the B-pillar on the right side. Then, for example, when the driver steers the vehicle 2 to the right, if a pedestrian approaches, the radar module 51 sends a proximity signal. After receiving the proximity signal, the image retrieval module 30 outputs a partial three-dimensional blind spot image I_{D} corresponding to an A-pillar on the left side, to enable a display module 40 on the A-pillar on the left side to display an outside image blocked by the A-pillar on the left side, to prevent the driver from missing the pedestrian because of being blocked by the A-pillar on the left side. Therefore, by means of the present invention, corresponding to the approach of an object from a different position, an outside view blocked by a corresponding vehicle body pillar 3 can be displayed on the vehicle body pillar 3, thereby achieving the function and objective of improving the driving safety.

In another embodiment, the present invention may alternatively determine, by using external images (that is, the vehicle-body front-side image I_{F}, the vehicle-body rear-side image I_{B}, the vehicle-body left-side image I_{L}, and the vehicle-body right-side image I_{R} photographed by the lens group 10), the approach of an object around the vehicle 2 to output a proximity signal. The present invention is not limited thereto. For example, after receiving the external images, the three-dimensional image processing module 20 further determines whether an object is approaching in the images, and outputs a proximity signal if an object is approaching.

In an embodiment, the image retrieval module 30 outputs, corresponding to a turn signal, at least one of the partial three-dimensional blind spot images I_{D}. For example, the image retrieval module 30 may be electrically connected to a turn signal controller (for example, a direction lever) of the vehicle 2, to receive the turn signal (for example, a left turn signal or a right turn signal). For example, when receiving a left turn signal, the image retrieval module 30 may output partial three-dimensional blind spot images I_{D} corresponding to an A-pillar on the left side and a B-pillar on the left side, to enable display modules 40 on the A-pillar on the left side and the B-pillar on the left side to display outside views blocked by the A-pillar on the left side and the B-pillar on the left side, so as to prevent the driver from being blocked on the left side to improve steering safety. In contrast, when receiving a right turn signal, the image retrieval module 30 may output partial three-dimensional blind spot images I_{D} corresponding to an A-pillar on the right side and a B-pillar on the right side, so as to prevent the driver from being blocked on the right side to improve steering safety.

As shown in FIG. 7, in this embodiment, each display module 40 is completely covered on an inside surface of a corresponding vehicle body pillar 3, to enable each partial three-dimensional blind spot image I_{D} and an actual view around the corresponding vehicle body pillar 3 (that is, the actual view that a driver sees through a windshield and side windows) to be stitched to each other. That is, each vehicle body pillar 3 presents a completely transparent state. However, the present invention is not limited thereto. In another implementation aspect, each display module 40 may alternatively be located on a partial inside surface of a corresponding vehicle body pillar 3 and extends to both edges of the vehicle body pillar 3, so that similarly, each partial three-dimensional blind spot image I_{D} and an actual view around the corresponding vehicle body pillar 3 can be stitched to each other, thereby achieving the advantages of providing an outside image sufficient for a driver to recognize and further reducing the costs.

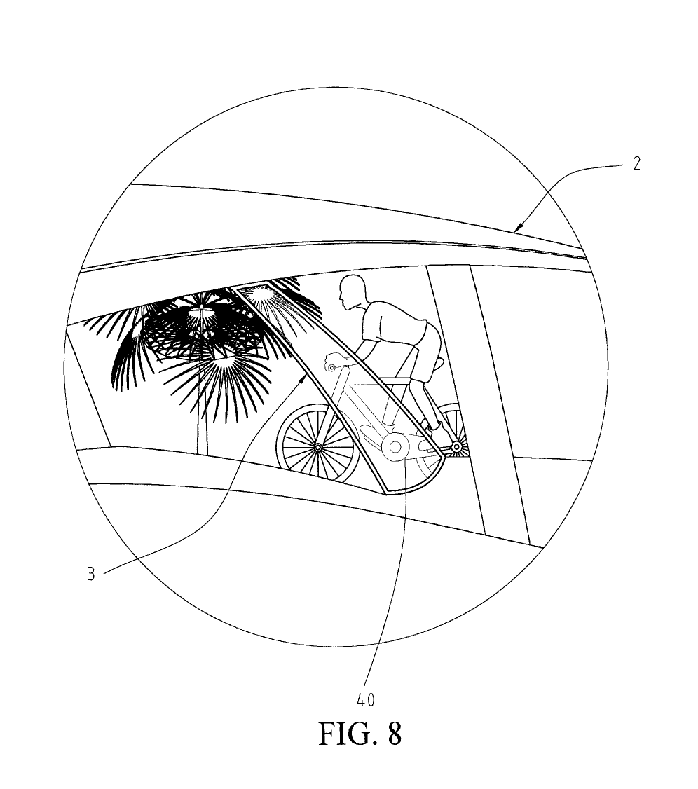

As shown in FIG. 8, in this embodiment, each display module 40 is located on a partial inside surface of a corresponding vehicle body pillar 3, and distances are left between the partial three-dimensional blind spot images I_{D} and an actual view around the corresponding vehicle body pillar 3 (that is, the actual view that a driver sees through a windshield and side windows). That is, each partial three-dimensional blind spot image I_{D} and an actual view around the corresponding vehicle body pillar 3 are not stitched, thereby achieving the advantages of enabling the display modules 40 to display an outside image sufficient for a driver to recognize and further reducing the costs.

In conclusion, in the present invention, by means of image processing and synthesis, a three-dimensional panoramic projection image is first established, and then corresponding to parts of vehicle body pillars (for example, A-pillars, B-pillars or C-pillars of a vehicle or at least two of A-pillars, B-pillars or C-pillars), corresponding partial three-dimensional panoramic projection images are retrieved and displayed on the vehicle body pillars, so that a driver can see outside views blocked by the vehicle body pillars during driving, and a synthesized three-dimensional panoramic projection image further provides three-dimensional perception to realistically present the surrounding environment of the vehicle, thereby achieving the efficacy of meeting the position of the line of sight of a driver when the driver drives a vehicle and improving the driving safety.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A three-dimensional image driving assistance device, applied to a vehicle, the vehicle comprising a plurality of vehicle body pillars, and the three-dimensional image driving assistance device comprising:
a lens group, comprising a plurality of lenses, respectively disposed on different positions around the vehicle, and the lenses respectively photographing a plurality of external images around the vehicle and outputting the external images;
a three-dimensional image processing module, electrically connected to the lens group, and the three-dimensional image processing module receiving the external images, combining the external images into a planar panoramic image, then synthesizing the planar panoramic image into a three-dimensional panoramic projection image by using a back projection manner, and outputting the three-dimensional panoramic projection image;
an image retrieval module, electrically connected to the three-dimensional image processing module, and the image retrieval module receiving the three-dimensional panoramic projection image, retrieving a part of the three-dimensional panoramic projection image, and converting the part of the three-dimensional panoramic projection image into a plurality of partial three-dimensional blind spot images, wherein the partial three-dimensional blind spot images respectively correspond to outside views blocked by the vehicle body pillars, and the image retrieval module selectively outputs at least one of the partial three-dimensional blind spot images; and
a plurality of display modules, electrically connected to the image retrieval module, the display modules being respectively disposed on the vehicle body pillars, and each display module receiving and displaying a partial three-dimensional blind spot image of a corresponding vehicle body pillar.

2. The three-dimensional image driving assistance device according to claim 1, wherein the lens group comprises:
a left-view lens, mounted on a left side of the vehicle, and the left-view lens photographing and outputting a vehicle-body left-side image;
a right-view lens, mounted on a right side of the vehicle, and the right-view lens photographing and outputting a vehicle-body right-side image;
a rear-view lens, mounted on a rear side of the vehicle, the rear-view lens photographing and outputting a vehicle-body rear-side image, wherein the vehicle-body rear-side image and the vehicle-body left-side image at least partially overlap, and the vehicle-body rear-side image and the vehicle-body right-side image at least partially overlap; and
a front-view lens, mounted on a front side of the vehicle, the front-view lens photographing and outputting a vehicle-body front-side image, wherein the vehicle-body front-side image and the vehicle-body left-side image at least partially overlap, and the vehicle-body front-side image and the vehicle-body right-side image at least partially overlap.

3. The three-dimensional image driving assistance device according to claim 1, wherein the three-dimensional image processing module projects the external images onto a 3D panoramic model to synthesize the three-dimensional panoramic projection image, and a coordinate center position of the 3D panoramic model corresponds to the position of a driver of the vehicle.

4. The three-dimensional image driving assistance device according to claim 1, further comprising a GPS module, electrically connected to the image retrieval module, wherein the GPS module is disposed at the vehicle and detects and outputs vehicle position information, and the image retrieval module selectively outputs, corresponding to the vehicle position information, at least one of the partial three-dimensional blind spot images.

5. The three-dimensional image driving assistance device according to claim 1, further comprising a radar module, electrically connected to the image retrieval module and disposed outside the vehicle, wherein the radar module detects the approach of an object around the vehicle to output a proximity signal, the image retrieval module selectively outputs, corresponding to the proximity signal, at least one of the partial three-dimensional blind spot images.

6. The three-dimensional image driving assistance device according to claim 1, wherein the three-dimensional image processing module further determines the approach of an object around the vehicle according to the external images to output a proximity signal, and the image retrieval module selectively outputs, corresponding to the proximity signal, at least one of the partial three-dimensional blind spot images.

7. The three-dimensional image driving assistance device according to claim 1, wherein the image retrieval module selectively outputs, corresponding to a turn signal, at least one of the partial three-dimensional blind spot images.

8. The three-dimensional image driving assistance device according to claim 1, wherein the vehicle body pillars are a plurality of A-pillars, a plurality of B-pillars or a plurality of C-pillars of the vehicle or a combination of at least two of the A-pillars, B-pillars or C-pillars.

9. The three-dimensional image driving assistance device according to claim 1, wherein each partial three-dimensional blind spot image and an actual view around a corresponding vehicle body pillar are stitched to each other.

10. The three-dimensional image driving assistance device according to claim 1, wherein each display module is a flexible display, and the flexible display is disposed corresponding to surface curvature of each vehicle body pillar.
